(19) United States
(12) Patent Application Publication
(10) Pub. No.: US 2020/0404762 A1
(43) Pub. Date: Dec. 24, 2020

(54) DIRECT DRIVE LIGHTING PROTECTION CIRCUIT

(71) Applicant: Thomas E. STACK, Oxford, MI (US)

(72) Inventor: Thomas E. STACK, Oxford, MI (US)

(21) Appl. No.: 16/910,038

(22) Filed: Jun. 23, 2020

Related U.S. Application Data
(60) Provisional application No. 62/865,286, filed on Jun. 23, 2019.

(51) Int. Cl. H05B 45/54; H02M 3/158

(52) U.S. Cl. CPC H05B 45/54; H02M 3/1588

(57) ABSTRACT

A lighting system protection circuit is adapted to receive a rectified AC input voltage, with a voltage threshold detector. The circuit is configured to pass current to the protected lighting system below the predetermined voltage threshold and to shut off current above the predetermined value.

### REFERENCE TO RELATED APPLICATIONS

This application claims the benefit, under 35 USC sections 119 and 120, of the filing date of a current pending U.S. Provisional Application Ser. No. 62/865,286, filed on Jun. 23, 2019, entitled, “DIRECT DRIVE LIGHTING PROTECTION CIRCUIT”, the entirety of which is incorporated by reference herein and priority of which is claimed herein.

### FIELD OF THE INVENTION

This invention relates to electronic protection systems, in particular for lighting systems.

### BACKGROUND

LED and other light sources are typically sensitive to high current or voltage. Excessive electricity can overheat or otherwise damage them.

Some protection circuits put a resistor in series with a lamp load. This prevents externally applied power from overdriving the lamp circuit, but consumes power that could otherwise produce light.

Yet other protection circuits act as an “all or nothing” safeguard, as with opening a fuse or a relay. These safeguards either allow all voltage and current to pass through to the load, or completely shut off the load in case of excess voltage or amperage. Some protection systems do not allow lights to go on again until a fuse is replaced or a circuit breaker is reset. Thus a customer may literally be left in the dark from an excess voltage or current situation.

A need exists for a circuit that provides at least some light output in an electrically overdriven condition, without consuming excess power or producing waste heat.

### SUMMARY

The present invention meets this need through efficiently protecting a lighting system, while allowing some light output in a protection mode.

FIGS. 1 and 2 show prior art LED driver circuits 101 and 201, based on the Altoran ACS1404 Direct AC Line LED Driver chip. The schematics are featured in a manufacturer supplied data sheet.

FIG. 3A shows how prior art circuit 301 powers more of LED groups S1 through S4 as voltage increases along the AC power cycle, and fewer LED groups as voltage decreases along the AC cycle. Circuit 301 shows rectified voltage 352 and LED groupings S1 through S4 having independent current feeds IF1 through IF4.

The waveform 351 in FIG. 3B shows how the sums of current feeds IF1 through IF4 total as ILED1 through ILED4 to approximate a rectified sine wave.

Still, nothing limits overall current draw if applied voltage exceeds nominal AC peak voltage, for example 170 volts.

This type of direct drive circuit does not use a power transformer between the AC mains and the LEDs. This configuration has many advantages, including power efficiency and reduction in materials cost and weight. However at least one disadvantage exists in not using a power transformer to couple the mains electricity to the lighting system. For example, any mains power electrical surge will meet with one less intermediate circuit element to limit current and voltage reaching the lights.

To protect a direct drive lighting circuit without the bulk and weight of a power transformer, the present disclosure provides other means of surge and overvoltage protection. The disclosed inventive protection circuit uses semiconductors to efficiently limit the amount of power transfer during overvoltage conditions.

### BRIEF DESCRIPTION OF THE DRAWINGS

FIG. 1 shows an example prior art direct drive lighting system;

FIG. 2 shows yet another example prior art direct drive lighting system;

FIG. 3A graphically details LED group current flows for an example prior art direct drive lighting system;

FIG. 3B shows a prior art sample current vs. voltage representation through one half of a full wave AC power cycle;

FIG. 4 shows a protective circuit inserted within a lighting system as in FIGS. 1-2;

FIGS. 5A through 5C show results of operating the protective circuit in conjunction with the lighting system, as viewed with an oscilloscope;

FIG. 6 shows groupings of protection circuit features to provide a more general perspective of how the circuitry implements lighting system protection; and

FIG. 7 shows an alternate grouping of protection circuit features to provide another perspective of how the circuitry implements lighting system protection.

### DETAILED DESCRIPTION

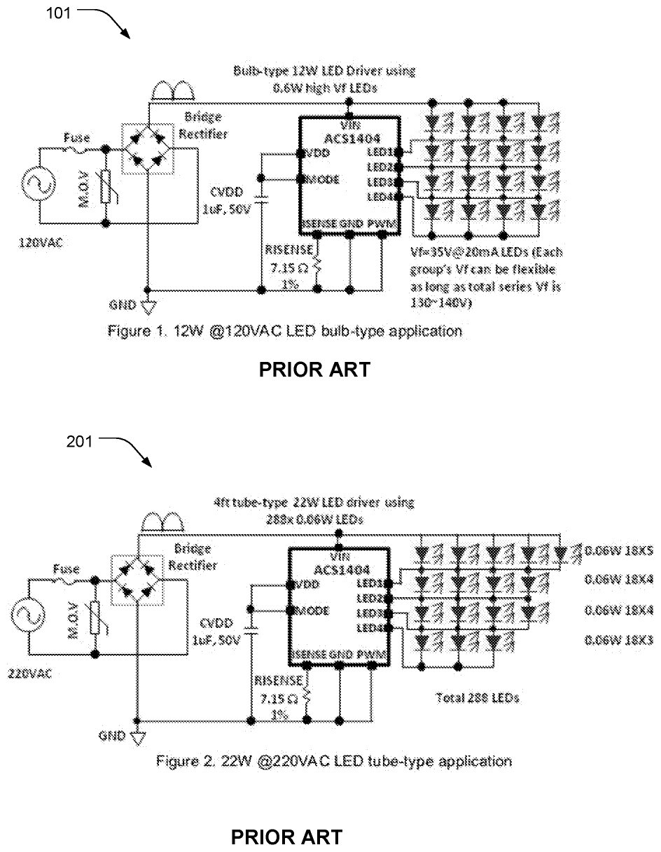

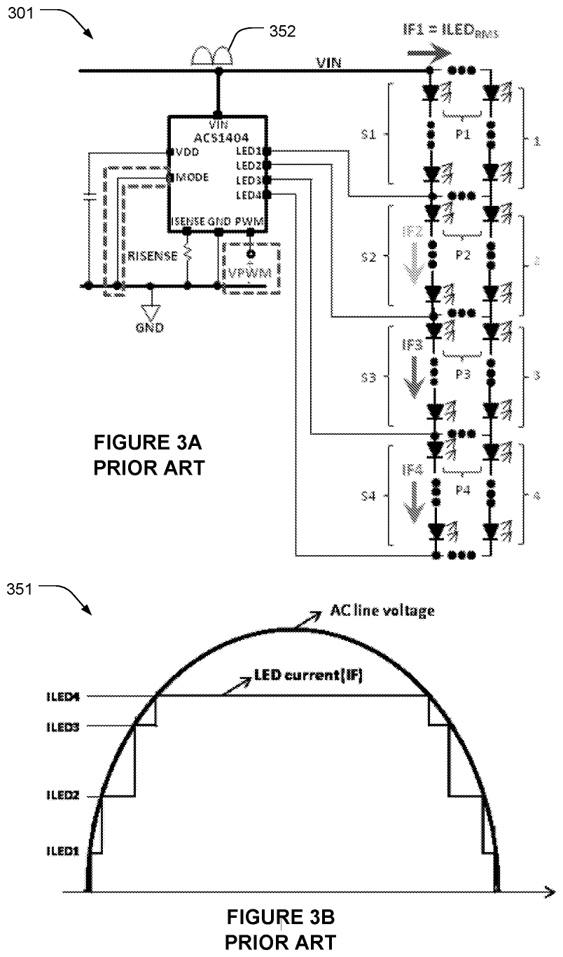

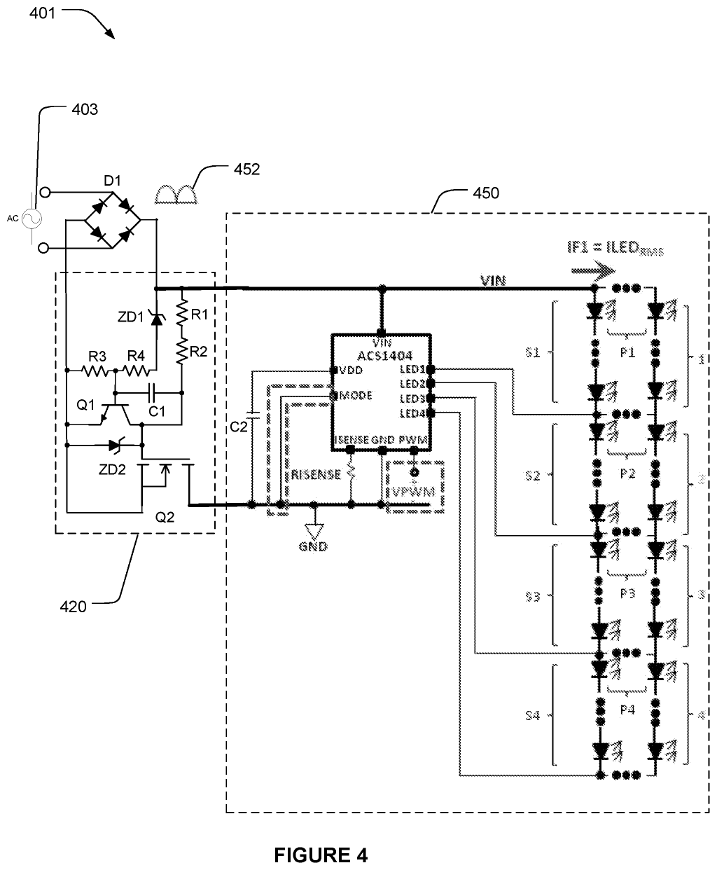

FIG. 4 shows a circuit system 401 partly based on FIGS. 1 and 2, but with an added block 420 that is placed between the bridge rectifier D1 and the IC ACS1404 in block 450. This block 420 protects the LED driver IC ACS1404 and lamps contained in block 450. In case of over voltage detection, circuit 420 turns off current to block 450.

Here is a theory of operation. Diode bridge D1 rectifies externally supplied AC source voltage to provide a rectified voltage waveform 452 that is applied to the protection block 420. A symbolic AC source 403 is shown separately.

Within block 420, below a voltage protection threshold, the series combination of R1, R2, and ZD2 will keep Q2 turned on. This allows Q2 to pass current to the lighting system under normal conditions, below an over voltage threshold.

A voltage protection threshold results from a pathway of the rectified output from rectifier bridge D1 being passed through Zener diode ZD1 and the voltage divider comprised of R3 and R4. Above a certain applied voltage output 452 from the bridge rectifier D1, the Q1 base to emitter voltage will reach approximately 0.7 volts, thus turning on Q1. This will in turn reduce the gate to source voltage on Q2, consequently reducing current flow through block 420.

Methods for determining switch on and switch off threshold voltages for a combination of diodes, transistors, and passive components are well known in the art.

Other detail is that having a combination of R1 and R2 instead of just one resistor is to reduce the voltage drop per resistor. C1 retains charge from times when cyclic voltage 452 is high to keep Q2 turned on when the voltage 452 is near zero.

In summary, with excessive applied voltage from the AC source 403, the Zener diode ZD1 turns on, passing current to turn on transistor Q1. Turning on Q1 reduces the Q2 gate to source voltage, causing less conduction through Q2. The rectified voltage 452 and hence supply voltage 403 will therefore effectively be disconnected from the lighting system 450 under excessive voltage conditions.

Beneficially, this arrangement prevents the disadvantage of completely turning off the LEDs through the entire conduction cycle. Some current can still pass through to the LEDs at the low voltage regions of the conduction cycle. A sequence of oscilloscope screen captures show the behavior given different applied voltage amplitudes.

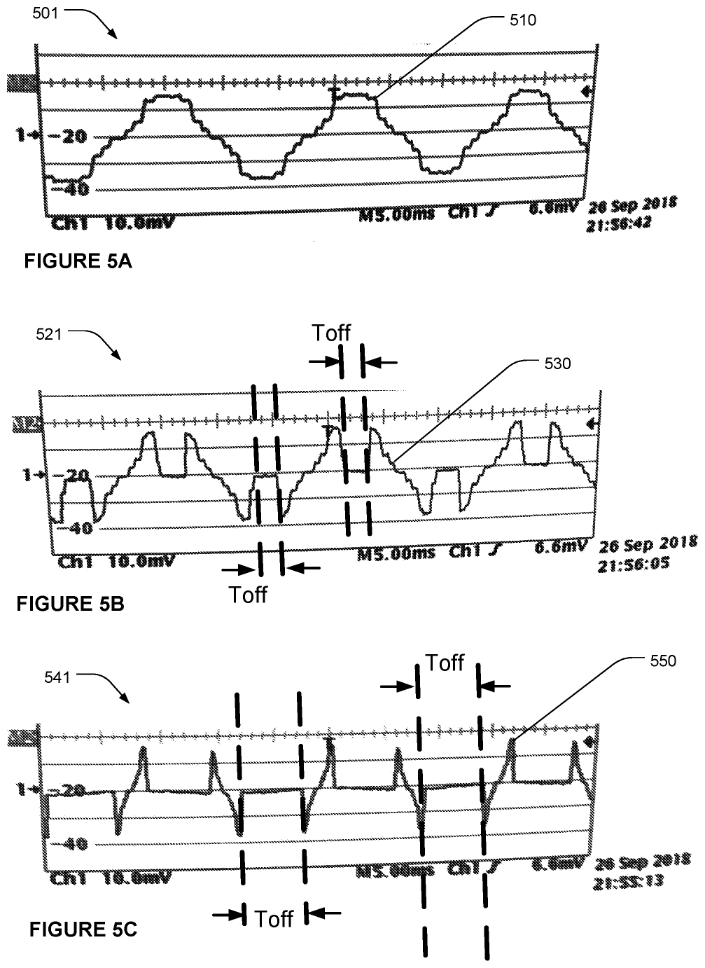

The oscilloscope trace 501 in FIG. 5A shows conduction in waveform 510 through nearly the entire AC voltage cycle. This is the nominal voltage case, for example 120 VAC applied voltage.

FIG. 5B shows an oscilloscope trace 521 with Toff (off time) during cycle peaks of waveform 530 as when the protection circuit activates and interrupts current flow to the lighting system. This is representative of, for example an overvoltage condition of 150 VAC applied voltage.

As the voltage increases, the Toff duration increases and the LEDS receive less power through the conduction cycle. Thus some light output occurs without damaging the IC and lamp load. This situation is shown in oscilloscope trace 541 FIG. 5C, featuring a more extended Toff than in FIG. 5B. Waveform 550 is representative of, for example an overvoltage condition of 270 VAC applied voltage.

Though the above descriptions may imply a sharp turnoff voltage threshold, this need not be the case for the protection circuit to be effective. An effective protection results when the output current is substantially reduced above an input voltage threshold, substantially here meaning that the current through the load is reduced to a safe level compared to what it would be without the protection circuit.

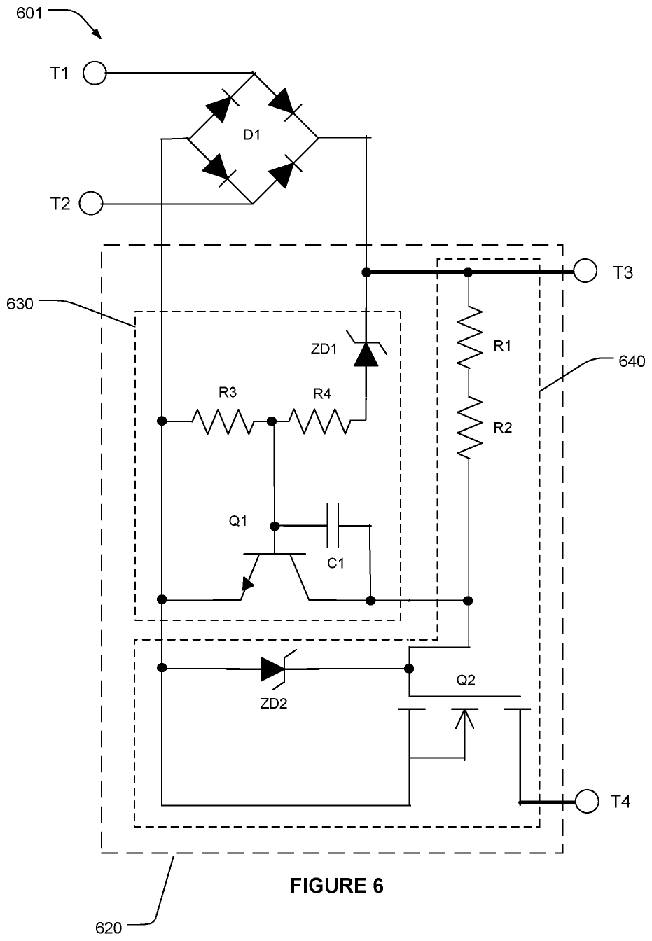

To further generalize the circuit behavior, FIG. 6 shows the subsystem 601 to emphasize circuit protection features. Components within block 420 are shown rearranged into equivalent block 620 and subdivided into sub-blocks 630 and 640. Sub-block 630 acts as a voltage threshold detector. Sub-block 640 acts as a device responsive to the voltage threshold detector. In combination with the detector 630, device 640 will shut off current to a protected lighting system connected to terminals T3 and T4 when voltage applied to terminals T1 and T2 exceeds a predetermined threshold.

### CONCLUSIONS, RAMIFICATIONS, AND SCOPE

While the circuit implementation shows a particular arrangement of bipolar and FET transistors, substitution of other transistor types in place of those shown is expected to produce substantially the same results. Also the polarity of each element could be reversed without substantially changing the operation of the circuit.

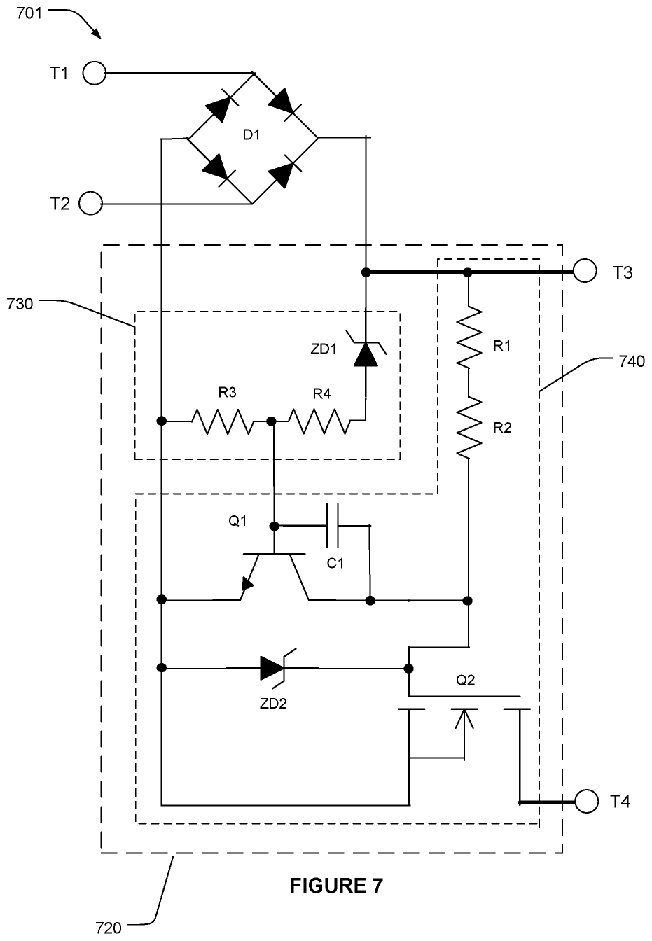

Further, the dividing line between the voltage threshold detector and the device responsive to the detector is subject to interpretation. For example, the boundary could be drawn as in the circuit partition 701 of FIG. 7 with sub-block 730 acting as a voltage threshold detector and sub-block 740 acting as a device responsive to the voltage threshold detector. The point is that overall the circuit 720 protects the load at terminals T3 and T4 when the voltage between terminals T1 and T2 is too high.

Further a pathway between the input voltage detection circuitry and the output current control device could be through an optoisolator instead of direct electrical connection.

Overall, the protection circuit provides an advantage over previous prior art systems that shut down completely well before reaching twice nominal input voltage. Though it performs better than prior art, its range to allow some light output has limitations. Were applied voltage to exceed well over twice mains voltage, there would be substantial power shutdown over the entire AC cycle, as Toff duration increases to fit nearly the entire cycle time. However the circuit could withstand moderate overvoltage without damage to the lighting load, and the circuit would automatically recover.

Because the design shuts off current for at least part of the power cycle during excessive voltage input, this may result in noticeable flicker at the light output. One way to reduce this is to position LED strings so that those with the shortest ON duty cycle are close to those with the longest duty cycle. Also, at least one capacitor in parallel with at least one LED string may reduce noticeable flicker.

It would be reasonable to use the protection circuit in conjunction with other lighting systems supplied by a pulsed or rectified time varying waveform. This could include LEDs in series with a resistor, or even an incandescent bulb.

Whether alone or in combination with a parallel transient protection system, the direct drive protection system effectively prevents lighting circuit damage, while allowing some light output where other protection systems don't, and without wasting electricity.

1. A lighting system protection circuit adapted to receive a rectified AC input voltage, comprising:
a voltage threshold detector,
a device responsive to the voltage threshold detector when the voltage threshold exceeds a predetermined value,
wherein the device shuts off current to the protected lighting system above the predetermined value; and
wherein the device passes current to the protected lighting system below the predetermined value.

2. A lighting system protection circuit as in claim 1,
wherein the voltage threshold detector is a Zener diode in series with a resistor voltage divider.

3. A lighting system protection circuit as in claim 1,
wherein the device has a first transistor circuit having an input for connection to an output of the voltage threshold detector,
the first transistor circuit having an output for connection to the input of a second transistor circuit, and
the second transistor circuit having an output that is adapted for series connection with power feed to a lighting system.

4. A lighting system protection circuit as in claim 3, wherein
the first transistor circuit has a collector connected to a first polarity of the rectifier output through at least one resistor,
the first transistor circuit has a base connected to the collector through at least one capacitor, and;
the first transistor circuit has an emitter connected to a second polarity of the rectifier output.

5. A lighting system protection circuit as in claim 3, wherein
the second transistor circuit has a gate connected to a source through a second Zener diode,
the source of the second transistor circuit is connected to an output of the rectifier, and;
the second transistor circuit has a drain for connection in series with the protected lighting system.

6. A lighting system protection circuit with terminals adapted to receive a rectified AC input voltage, comprising:
a first terminal connected to a Zener diode in series with a voltage divider connected to a second terminal, the divider having an output,
a first transistor circuit having an input with connection to the divider output, further having an output that changes with respect to input voltage,
a second transistor circuit responsive to the first transistor circuit, further having a pathway between a third and fourth terminal through which current may pass,
wherein the second transistor circuit substantially reduces current through the pathway between the third and fourth node above a threshold voltage applied to the input of the first transistor circuit.

7. A lighting system protection circuit as in claim 7
wherein the first transistor circuit reduces output voltage as input voltage increases.
